(19) United States
(12) Patent Application Publication
(10) Pub. No.: US 2020/0189016 A1
(43) Pub. Date: Jun. 18, 2020

(54) METHOD FOR INSPECTING A DRESSABLE WORM GRINDING WHEEL

(71) Applicant: Klingelnberg AG, Zurich (CH)

(72) Inventors: Martin Schweizer, Rastatt (DE); Sergej Amboni, Malsch (DE)

(21) Appl. No.: 16/712,435

(22) Filed: Dec. 12, 2019

(30) Foreign Application Priority Data
Dec. 12, 2018 (DE) 102018131915.0

(51) Int. Cl. B23F 23/12; B23F 11/00

(52) U.S. Cl. CPC B23F 23/1231; B23F 11/00

(57) ABSTRACT

A method for inspecting a dressable worm grinding wheel, having the following method steps:
providing a dressable worm grinding wheel in a machine tool,
wherein the worm grinding wheel has at least one worm thread and
wherein the machine tool comprises a dressing tool for dressing the worm grinding wheel;
traveling along a thread head of the worm thread in contact with a region of the dressing tool;
measuring and analyzing at least one signal during the travel along the thread head, which is characteristic for the contact between the dressing tool and the thread head of the worm thread, such as a contact force, a displacement, a structure-borne noise, a power consumption of a drive, or the like.

### CROSS-REFERENCE TO RELATED APPLICATIONS

This application claims the benefit under 35 U.S.C. § 119(e) to German patent application no. DE 10 20 181 319 15.0 filed Dec. 12, 2018, which is hereby expressly incorporated by reference as part of the present disclosure.

### FIELD OF THE INVENTION

The present disclosure relates to a method for inspecting a dressable worm grinding wheel.

### BACKGROUND

Worm grinding wheels are used in particular for the fine machining of metallic workpieces having cyclically symmetrical outer contour, such as gear wheels or the like. To achieve a high machining accuracy by way of the grinding machining, it is of decisive importance that the profiling regions of the worm grinding wheel are undamaged and the fundamental geometry of the worm grinding wheel, for example, the thread number (the number of threads on the worm grinding wheel) or the thread direction (the direction the threads run around the worm grinding wheel), corresponds to the target specifications for the workpiece to be ground.

Damage can thus occur on the worm grinding wheel, for example, due to the transportation or the installation of the worm grinding wheel. The worm grinding wheel can be damaged by operator or machine errors during configuration in the state installed on the machine tool. The worm grinding wheel can be damaged by overload during the grinding machining.

All above-mentioned cases, in which damage to the profiling regions of the worm grinding wheel occurs, share the feature that typically a thread head of a worm thread of the worm grinding wheel is interrupted at at least one point. The thread head forms the outer diameter of a worm grinding wheel and as a result of elevated stresses during the grinding machining forms a mechanical weak point, on the one hand, and is a frequently affected collision structure in the case of an operator or machine error because of the exposed location, on the other hand. Therefore, if damage occurs to the profiling regions, the thread head of a worm thread of the worm grinding wheel is usually affected.

Furthermore, operator errors can occur during the installation of the worm grinding wheel. It can thus occur that the thread number or thread direction input by the operator are incorrect and do not match with the actually installed worm grinding wheel.

If grinding machining is started in spite of the presence of one of the above errors, damage to the machine tool and the worm grinding wheel and also the production of reject parts can occur.

Inspecting the contact between the dressing roller and the worm grinding wheel during the dressing procedure of the worm grinding wheel in order to detect damage to the worm grinding wheel is known.

However, it is disadvantageous in this case that damage to a worm thread frequently occurs locally and not extending over the entire thread height, so that the contact between the dressing roller and the worm grinding wheel is not completely interrupted. Local breaks in the region of a thread head of the worm grinding wheel thus cannot be reliably detected. This damage in the region of the thread head results in significant quality losses of the subsequent grinding machining of the workpieces to be manufactured, however.

### SUMMARY

Against this background, the present disclosure is based on the technical problem of specifying a method which partially or completely achieves the above-mentioned requirement.

According to at least some embodiments, the present disclosure relates to methods for inspecting a dressable worm grinding wheel, having the following method steps:

providing a dressable worm grinding wheel in a machine tool,

wherein the worm grinding wheel has at least one worm thread and

wherein the machine tool comprises a dressing tool for dressing the worm grinding wheel;

traveling down a thread head of the worm thread in contact with a region of the dressing tool;

measuring and analyzing at least one signal during the travel along the thread head which is characteristic for the contact between the dressing tool and the thread head of the worm thread, such as a contact force, a displacement, a structure-borne noise, a power consumption of a drive, or the like.

The dressing tool is therefore used in at least some embodiments as a scanning or inspecting device to check the quality of the worm grinding wheel.

The thread head of the worm thread can therefore in at least some embodiments be continuously scanned or traveled with the aid of the dressing tool and thus be checked for damage. Furthermore, the travel along the thread head enables a detection of an incorrect thread number or thread direction of the worm grinding wheel.

With the aid of the method, efficient checking of the worm grinding wheel can therefore be implemented, for example, on existing grinding machines, since an additional measuring unit is not required for the checking according to at least some embodiments of the worm grinding wheel.

It can be provided that the travel along the thread head of the worm thread takes place in contact with an outer-diameter-side region of the dressing tool. The scanning of or traveling along the thread head can thus take place inside the machine tool using a simple axial kinematic.

Alternatively, it can be provided that the travel along the thread head of the worm thread takes place in contact with a flank-side region of the dressing tool which adjoins the outer-diameter-side region of the dressing tool. The dressing tool can thus be pivoted in relation to the thread head and brought into contact therewith in such a way that a flank of the dressing tool provided for dressing a flank of the worm thread is used for traveling along or scanning the thread head of the worm thread of the worm grinding wheel.

If, for example, a gearing is to be ground with the aid of the worm grinding wheel, the target geometry of the gearing-specific associated worm grinding wheel can be stored in a controller of the machine tool or manually input. In the method step “travel along the thread head”, a region of the dressing tool, for example an outer-diameter-side region of the dressing tool, is brought into contact with the thread head of the worm thread of the worm grinding wheel and then travels along a predetermined target spiral path of the thread head of the worm thread of the worm grinding wheel.

It can be provided that the analysis of at least one signal comprises a comparison of the signal to a reference signal.

If the worm grinding wheel meets the predetermined target geometry, an essentially continuous contact with the outer diameter of the dressing tool results during the travel along the spiral path of the thread head of the worm thread, so that the measured signal is located within a predetermined target range around the reference value or the reference signal.

Alternatively, it can be provided that the measured signal is analyzed without a predetermined reference signal being provided as a comparison value. A measured signal can thus be analyzed in at least some embodiments internally in the machine or on an external computer and be studied, for example, for local maxima, minima, or signal interruptions.

If the thread head has breaks or the contact between the dressing tool and the thread head is interrupted, a sudden change or an interruption of the characteristic signal occurs.

A complete loss of contact of the dressing tool with the thread head along the predetermined target spiral path of the thread head of the worm thread of the worm grinding wheel thus indicates an incorrect thread number or thread direction of the worm grinding wheel.

Sudden changes of the characteristic signal indicate that the dressing roller has traveled over a break or damage of the thread head.

When reference is made in the present case to the thread head of the worm thread, in this case this refers to an outer-diameter-side part of the profile of the worm thread which connects a left and right profile flank of the profile of the worm thread on the outer diameter side.

According to at least some embodiments, it can be provided that

the thread number of the worm grinding wheel,

the thread direction of the worm grinding wheel, and

the integrity of the thread head of the worm thread of the worm grinding wheel are checked automatically by the steps traveling along, measuring, and comparing. “Integrity,” as used herein with respect to the thread head, means the absence of damage to the thread head.

In addition to the conventional monitoring of the dressing procedure, the method can additionally be automatically applied within a machine tool in order to avoid or recognize the errors mentioned at the outset, which occur frequently in practice.

It can be provided that the travel along the thread head is performed as an additional work step after installation of the worm grinding wheel and/or scanning of the worm grinding wheel and/or after dressing of the worm grinding wheel and/or before grinding machining of a workpiece of a series, for example every grinding machining of a workpiece of a series. During scanning, the dressing tool is caused to travel along the thread head and to repeatedly touch the worm grinding wheel. Scanning may involve a relative lifting/withdrawing and approaching/contacting (e.g., up and down) movement of the dressing tool and the worm grinding wheel. Accordingly, in at least some embodiments the detection of breaks in the region of the thread head of the worm thread can be incorporated in a simple manner into existing program sequences of a machine tool in order to reduce the production of rejects.

According to at least some embodiments of the method, it is provided that the worm grinding wheel has two or more threads, wherein the worm threads are sequentially checked by a separate pass of the travel along and measurement being performed for every worm thread. I.e., in other words, every worm thread is checked individually for flaws. After a first worm thread of the two-thread or multi-thread worm grinding wheel has been traveled along, subsequently a second and then, if provided, all further worm threads are traveled along using the dressing tool.

The comparison of the characteristic signal to the reference signal can take place during and/or after the travel along the worm thread or the worm threads.

Precisely one characteristic signal can be acquired, which is representative or characteristic for the contact between the dressing tool and the worm grinding wheel when traveling along the thread head of the worm thread.

Alternatively, two or more characteristic signals can be acquired, which are representative or characteristic for the contact between the dressing tool and the worm grinding wheel when traveling along the thread head of the worm thread.

One, two, or more characteristic signals can be selected from the following list: contact force between the dressing roller and the worm grinding wheel; relative displacement between the dressing roller and the worm grinding wheel; absolute displacement of the dressing roller and/or the worm grinding wheel; structure-borne noise of the dressing roller and/or the worm grinding wheel and/or a receptacle of the dressing roller and/or the worm grinding wheel; power consumption of a rotary drive of the worm grinding wheel and/or the dressing roller. A maximum permissible deviation from a reference value can be defined for each of these parameters, and if this deviation is exceeded in absolute value, this forms an indication of one of the flaws discussed here, namely breaks on the thread head, an incorrect thread number, or an incorrect thread direction.

The dressing tool can be a disk-shaped dressing roller having V-shaped or trapezoidal profile. In the case of a disk-shaped dressing roller having V-shaped profile, an essentially punctiform contact exists between the worm grinding wheel and the dressing tool during the travel along the worm thread. In the case of a disk-shaped dressing roller having trapezoidal profile, an essentially punctiform or linear contact can be formed between the worm grinding wheel and the dressing tool during the travel along the worm thread, depending on the inclination of the dressing tool.

At least some embodiments of the method is distinguished in that the dressing tool is a multi-groove dressing roller for simultaneously dressing multiple worm threads, wherein an axis of rotation of the multi-groove dressing roller when traveling along the thread head of the worm thread is oriented inclined in relation to an axis of rotation of the worm grinding wheel. It can be ensured by the inclination that only one region of the dressing roller, for example an outer diameter of the multi-groove dressing roller or an outer-diameter-side region of the dressing roller, is in contact with a single thread head, so that a defined travel along a single thread head of a worm thread is performed analogous to the scanning of or traveling along the spiral path of the thread head with disk-shaped dressing roller. If further worm threads are provided, they are individually traveled along sequentially, i.e., in separate passes of the multi-groove dressing tool.

The dressing tool of at least some embodiments may comprise a head dresser.

According to at least some embodiments of the method, it is provided that for the case in which a deviation of the measured signal from the reference signal exceeds a predetermined maximum deviation, or an analysis of the signal displays one or more anomalies (if the signal is abnormal and/or does not meet one or more criteria that may be defined for the signal, which may be defined in a database, or by rules or a set of rules, then an anomaly/anomalies will be considered to exist), such as local maxima, minima, interruptions, or the like, one or more of the following steps are carried out:

interrupting a program sequence before grinding machining of a workpiece to be ground;

informing an operator;

adapting a shift strategy for the grinding machining;

dressing the worm grinding wheel. When the program sequence is interrupted before grinding machining of the workpiece, the program pauses or stops and so does not proceed to machine the workpiece with the anomalous or damaged worm grinding wheel.

If a flaw on the worm grinding wheel or an incorrect thread number or an incorrect thread direction is detected, one or more measures can thus be taken to ensure the required quality for the subsequent grinding process.

For example, the worm grinding wheel can be replaced after the interruption of the program sequence of the machine tool.

If local damage to a worm thread exists, it can be provided that a shift strategy for a subsequent grinding procedure is manually or automatically adapted in such a way that the damaged region of the worm grinding wheel does not engage with the component to be ground, so that the workpiece quality is not impaired by the damage to the worm grinding wheel.

The worm grinding wheel can be dressed using an elevated material removal, for example, in such a way that a detected damage is corrected.

This summary is not exhaustive of the scope of the aspects and embodiments of the invention. Thus, while certain aspects and embodiments have been presented and/or outlined in this summary, it should be understood that the inventive aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow, but in any case are not exhaustive or limiting.

It should also be understood that any aspects and embodiments that are described in this summary and elsewhere in this application and do not appear in the claims that follow are preserved for later presentation in this application or in one or more continuation patent applications.

### BRIEF DESCRIPTION OF THE DRAWINGS

Exemplary embodiments, which are understood not to be limiting, will be described in greater detail hereafter with reference to the drawings.

FIG. 1 schematically shows a worm grinding wheel and a gear wheel to be ground;

FIG. 2 schematically shows a worm grinding wheel and a dressing tool traveling along a worm thread;

FIG. 3 schematically shows the worm grinding wheel and the dressing tool of FIG. 2 in a subsequent position;

FIG. 4 schematically shows a multi-thread worm grinding wheel and a multi-groove dressing tool.

### DETAILED DESCRIPTION

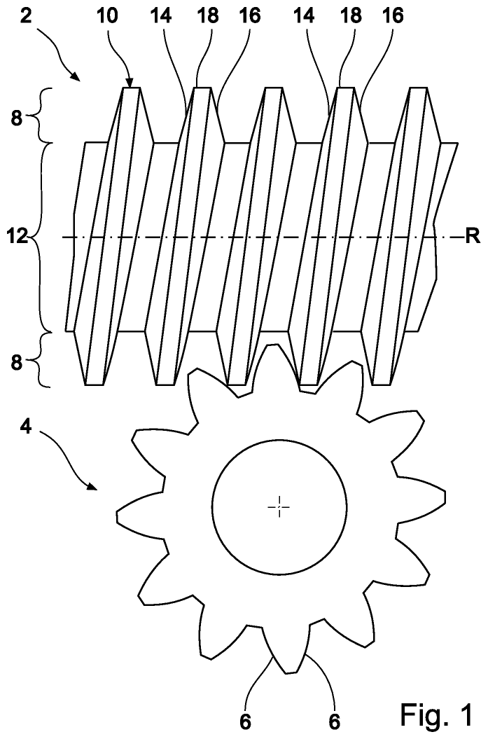

FIG. 1 shows a worm grinding wheel 2 and a gear wheel 4 to be ground. For fine machining of the tooth flanks 6 of the gear wheel 4, the worm grinding wheel 2 and the gear wheel 4 execute a coupled generating grinding movement in a known manner.

Before the grinding of the gear wheel 4, the worm grinding wheel 2 has been dressed to generate a shaping profile 8 of the worm grinding wheel. The profile 8 comprises a single worm thread 10 in the present case, which is wound in a spiral around a cylindrical middle part 12 of the worm grinding wheel

The worm thread 10 has a left flank 14, a right flank 16, and a thread head 18 connecting the flanks 14, 16. Like the flanks 14, 16, the thread head describes a spiral path wound around the cylindrical middle part 12 and the axis of rotation R of the worm grinding wheel 2.

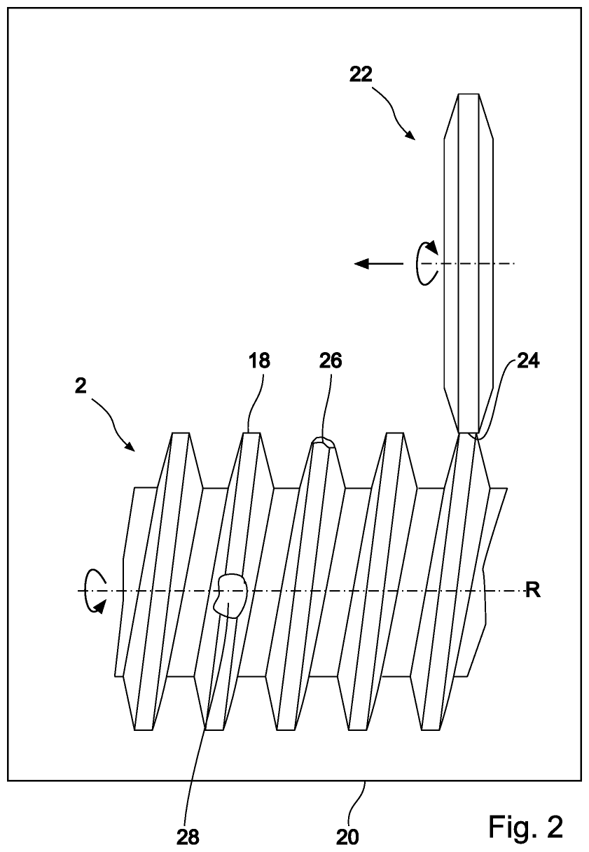

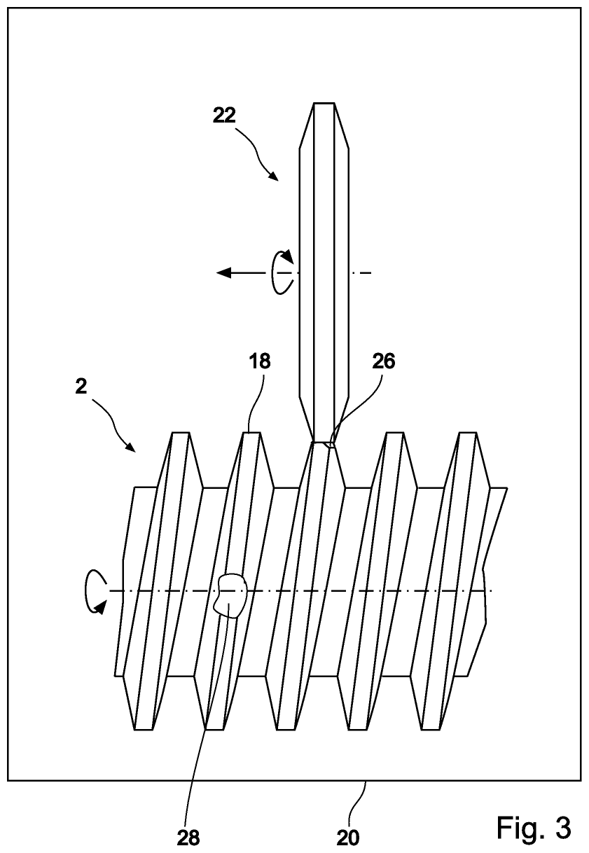

The method according to at least some embodiments is described hereafter with reference to FIGS. 2, 3, and 4.

A method for inspecting the dressable worm grinding wheel 2 shown in FIG. 1 is carried out. For this purpose, the worm grinding wheel 2 is firstly provided in a machine tool 20, wherein in the present case it is a gearing grinding machine.

The machine tool 20 has a dressing tool 22 for dressing the worm grinding wheel 2.

To check the thread number, the thread direction, and the integrity of the thread head 18, the thread head 18 of the worm thread 10 is traveled along in contact with an outer diameter of the dressing tool 22, in the present case an outer-diameter-side surface 24 of the dressing tool 22. In this case, this involves continuous rolling of the essentially cylindrical outer surface 24 of the dressing tool 22 on the spiral path surface which the thread head 18 describes.

It is obvious that in addition to the trapezoidal profile of the dressing tool shown here, according to alternative exemplary embodiments, a dressing tool having V-shaped or rounded profile can be used.

The relative movement between the dressing tool 22 and the worm grinding wheel 2 is indicated by the directional arrows. The disk-shaped dressing tool 22 and the worm grinding wheel 2 thus rotate in opposite directions, wherein the dressing tool 22 is moved axially along the slope of the worm thread 18.

During the travel along the thread head 18, signals are measured which are characteristic for the contact between the dressing tool and the thread head of the worm thread, for example a contact force, a displacement, a structure-borne noise, and the power consumption of the drives.

The contact force between the dressing tool 22 and the thread head 18 is measured during the travel along the thread head. If a sudden drop of the contact force results because the dressing roller 22 rolls over damage 26, 28 of the thread head 18 (cf. FIG. 2), the damage 26 or 28 can be detected. In this case, for example, it can be predetermined that a deviation of +/− 10% of a predetermined target contact force, which forms the reference, triggers an error message or interruption of a program sequence.

In a similar manner, a target axial distance between the axis of rotation, a target structure-borne noise excitation during the travel along, or a target power consumption of the axial drives can be used to form a reference for the travel along the thread head and to use deviations thereof as an indication of damage to the thread head.

The measured signal is accordingly compared to an above-described reference to recognize damage of the thread head.

It is apparent that the above parameters are similarly suitable for detecting an incorrect thread number or thread direction of the worm grinding wheel, for which a contact between the dressing roller and the worm grinding wheel would break away completely, since the dressing roller travels along a predetermined target path of a target worm grinding wheel geometry having correct thread direction and thread number.

The method is carried out completely automatically in the present case, so that the thread number of the worm grinding wheel 2, the thread direction of the worm grinding wheel 2, and the integrity of the thread head 18 of the worm thread 10 of the worm grinding wheel 2 are checked automatically by the steps of traveling along, measuring, and comparing.

The travel along the thread head 18 of the worm grinding wheel 2 is performed in the present case as an additional work step after dressing of the worm grinding wheel 2 and before grinding machining of a workpiece of a series of workpieces to be manufactured, for example before every grinding machining of a workpiece of a series of workpieces to be manufactured.

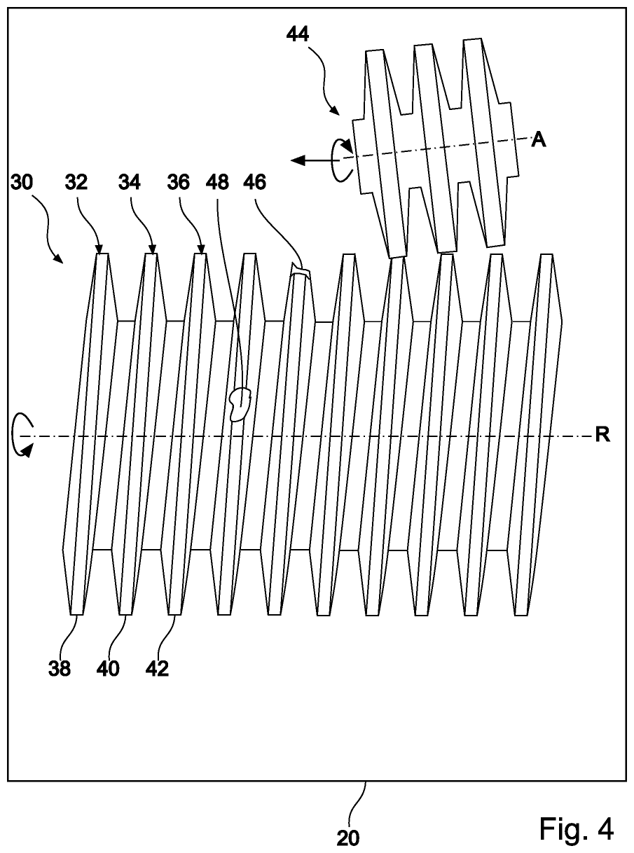

FIG. 4 shows a variant of the method according to at least some embodiments in which a worm grinding wheel 38 has three threads 32, 34, 36, with a respective thread head 38, 40, 42. The worm threads 32, 34, 36 are checked sequentially here by a separate pass of the travel along and measuring being performed for every thread head 32, 34, 36.

A dressing tool 44 is used for this purpose, which is a multi-groove dressing roller 44 for simultaneously dressing the worm threads 32, 34, 36. An axis of rotation A of the multi-groove dressing roller 44 is oriented inclined in relation to the axis of rotation R of the worm grinding wheel 30 during the travel along a respective thread head 38, 40, 42 of a respective worm thread 32, 34, 36, wherein in the present case the travel along the thread head 38 of the worm thread 32 is shown by way of example.

Damage 46 of the thread head 40 of the worm thread 34 is therefore first recognized when the thread head 40 of the worm head 34 is traveled along or scanned in a separate pass using the dressing tool 44, while the damage 48 of the thread head 38 of the worm thread 32 is recognized in the pass of the dressing tool 44 along the spiral path of the thread head 32 shown in FIG. 4.

For the case that, for one of the worm grinding wheels 2, 30 shown, a deviation of the measured signal from the reference signal exceeds a predetermined maximum deviation, in the present case one or more of the following steps are carried out: interrupting a program sequence before grinding machining of a workpiece to be ground; informing an operator; adapting a shift strategy for the grinding machining; dressing the worm grinding wheel.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A method comprising:
chucking a dressable worm grinding wheel in a machine tool, wherein the worm grinding wheel defines at least one worm thread defining a thread head;
chucking a dressing tool in the machine tool, wherein the dressing tool is adapted to dress the worm grinding wheel;
moving a surface of the dressing tool in contact with and along the thread head of the worm thread; and
during the moving step, measuring and analyzing at least one signal representing a characteristic of said contact between the dressing tool and the thread head of the worm thread.

2. The method according to claim 1, wherein said surface defines an outer-diameter-side surface of the dressing tool.

3. The method according to claim 1, wherein said analyzing step includes comparing the at least one signal to a reference signal.

4. The method according to claim 3, further including automatically determining a thread number of the worm grinding wheel, a thread direction of the worm grinding wheel, and integrity of the thread head of the worm thread of the worm grinding wheel during the moving, measuring, and comparing steps.

5. The method according to claim 1, including performing the moving step
after the chucking of the worm grinding wheel;
after scanning the worm grinding wheel;
after dressing the worm grinding wheel with the dressing tool; and/or
before grinding machining with the worm grinding wheel a workpiece of a series of workpieces.

6. The method according to claim 1, wherein the worm grinding wheel defines at least two worm threads, and the method includes sequentially performing the moving step and the measuring step with each of the at least two worm threads.

7. The method according to claim 1, wherein the dressing tool defines a disk-shaped dressing roller defining a V-shaped or a trapezoidal profile.

8. The method according to claim 1, wherein
the dressing tool defines a multi-groove dressing roller adapted to simultaneously dress multiple worm threads, and
during the moving step, an axis of rotation of the multi-groove dressing roller is oriented inclined relative to an axis of rotation of the worm grinding wheel.

9. The method according to claim 1, wherein
the method further includes, when a deviation of the measured at least one signal from a reference signal therefor exceeds a predetermined maximum deviation, or an analysis of the at least one signal shows one or more anomalies:
preventing grinding machining of a workpiece with the worm grinding wheel;
informing an operator;
adapting a shift strategy for the grinding machining; and/or
dressing the worm grinding wheel with the dressing tool.

10. The method according to claim 9, wherein the one or more anomalies include at least one local maximum, at least one local minimum, and/or a at least one worm gear thread interruption

11. The method according to claim 2, wherein said analyzing step includes comparing the at least one signal to a reference signal.

12. The method according to claim 11, further including automatically determining the thread number of the worm grinding wheel, the thread direction of the worm grinding wheel, and the integrity of the thread head of the worm thread of the worm grinding wheel during the moving, measuring, and comparing steps.

13. The method according to claim 2, including performing the moving step
after the chucking of the worm grinding wheel;
after scanning the worm grinding wheel;
after dressing the worm grinding wheel with the dressing tool; and/or
before grinding machining with the worm grinding wheel a workpiece of a series of workpieces.

14. The method according to claim 3, including performing the moving step
after the chucking of the worm grinding wheel;
after scanning the worm grinding wheel;
after dressing the worm grinding wheel with the dressing tool; and/or
before grinding machining with the worm grinding wheel a workpiece of a series of workpieces.

15. The method according to claim 4, including performing the moving step
after the chucking of the worm grinding wheel;
after scanning the worm grinding wheel;
after dressing the worm grinding wheel with the dressing tool; and/or
before grinding machining with the worm grinding wheel a workpiece of a series of workpieces.

16. The method according to claim 2, wherein the worm grinding wheel defines at least two worm threads, and the method includes sequentially performing the moving and measuring step for each of the at least two worm threads.

17. The method according to claim 3, wherein the worm grinding wheel defines at least two worm threads, and the method includes sequentially performing the moving and measuring step for each of the at least two worm threads.

18. The method according to claim 2, wherein the dressing tool defines a disk-shaped dressing roller defining a V-shaped or a trapezoidal profile.

19. The method according to claim 3, wherein the dressing tool defines a disk-shaped dressing roller defining a V-shaped or a trapezoidal profile.

20. The method according to claim 1, wherein the at least one signal represents (i) a contact force between the dressing tool and the worm grinding wheel, (ii) a relative displacement between the dressing tool and the worm grinding wheel, (iii) an absolute displacement of the dressing tool and/or the worm grinding wheel; (iv) a noise of the dressing tool and/or the worm grinding wheel generated during the moving step, and/or (v) a power consumption of a drive driving the dressing tool and/or the worm grinding wheel during the moving step.
